(19) United States
(12) Patent Application Publication
(10) Pub. No.: US 2015/0168564 A1
(43) Pub. Date: Jun. 18, 2015

(54) Scintillating Fiber Dosimeter for Magnetic Resonance Imaging Enviroment

(71) Applicant: Standard Imaging, Inc., Middleton, WI (US)

(72) Inventors: Brian Douglas Hooten, Middleton, WI (US); Thomas Christopher Bonde, Mazomanie, WI (US)

(21) Appl. No.: 14/571,669

(22) Filed: Dec. 16, 2014

Related U.S. Application Data
(60) Provisional application No. 61/917,544, filed on Dec. 18, 2013.

(51) Int. Cl. G01T 1/105; G01T 1/20

(52) U.S. Cl. CPC G01T 1/105; G01T 1/2002

(57) ABSTRACT

An x-ray detector for use in the presence of magnetic resonance imaging equipment provides a two-stage transmission path of optical fiber followed by a non-ferromagnetic shielded cable to displace measurement electronics outside of the concentrated magnetic and radiofrequency fields of the MRI device. Conversion from light to an electrical signal for this transmission path is provided by circuitry held in a non-ferromagnetic Faraday cage. In this way accurate x-ray measurements may be made in radiotherapy equipment working in conjunction with magnetic resonance imaging for accurate dose placement.

### CROSS-REFERENCE TO RELATED APPLICATIONS

This application claims the benefit of U.S. provisional application 61/917,544 filed Dec. 18, 2013, and hereby incorporated by reference.

### BACKGROUND OF THE INVENTION

External beam radiation therapy systems provide beams of high energy directed into a patient to treat tumors or the like. The size, location, angle and intensity of the beams are determined by a treatment plan which is based on known information about the pattern (intensity and distribution) of radiation produced by a particular radiation therapy machine.

Quantitative accuracy in the dose produced by the radiation plan requires accurate characterization of the radiation therapy machine. This characterization is normally done by making periodic measurements of the radiation beam using a single or multiple radiation detectors positioned in phantoms mimicking human tissue.

One type of radiation detector is a radiographic or radiochromic film. Such films may be used to assess radiation patterns and intensities but are subject to a number of drawbacks including temperature dependencies and limited precision. Alternatively, the radiation detectors may be semiconductor devices or ion detectors. These detectors may be preferred over films because of their ability to generate an electrical signal that may be instantaneously monitored by an appropriate instrument such as an electrometer.

There is increasing interest in radiation therapy machines that combine magnetic resonance imaging (MRI) systems with radiation therapy. In such machines, the MRI system may provide treatment-time monitoring of the tumor position for more accurate treatment.

Magnetic resonance imaging employs high-intensity magnetic fields and strong radiofrequency signals to stimulate water molecules of the tissue into precession. These electromagnetic fields can create havoc with relatively faint electrical signals produced by conventional electronic radiation detectors such as ion chambers and semiconductor devices.

### SUMMARY OF THE INVENTION

The present invention provides an x-ray detector that may be used with magnetic resonance imaging systems, Specifically, the detection system employs a fiber optic scintillation detector constructed of non-ferromagnetic electrically insulating materials that offers low interactivity with electromagnetic fields of the MRI device. The present inventors have determined that the fiber optic allows the detection electronics of the detection system to be sufficiently displaced from the imaging field of the MRI machine to acceptably minimize interaction with the field of the MRI machine. The use of ferromagnetic components in the detection electronics is also minimized.

One embodiment of the invention provides a radiation detector having a detection optical fiber communicating with a scintillating material responsive to radiation at a distal end and having a light detecting module communicating with the proximal end of the detection optical fiber to receive light through the detection optical fiber from the scintillating materials, the light detecting module providing at least one photodetector. A shielded cable communicates with the photodetector and is adapted to conduct an electrical signal from the photodetector to an electronic display remote from the photodetector. The light detecting module and shielded cable are substantially free from ferromagnetic materials.

It is thus a feature of at least one embodiment of the invention to practically integrate an x-ray detector into the MRI environment without the distortion of the MRI image for the generation of destructive eddy current flows that can occur with ferromagnetic or conductive materials.

The detection optical fiber may have a length no less than one meter long.

It is thus a feature of at least one embodiment of the invention to accommodate the demands of electronic sensing to the MRI environment by displacement of conductive sensor elements.

The invention may include a correction optical fiber having a different relative response to radiation at its distal end than the detection optical fiber has at its distal end. A processing electronic circuit may combine signals from the photodetectors to provide the electrical signal with reduced sensitivity to Cherenkov radiation generating light within each of the detection and correction optical fibers.

It is thus a feature of at least one embodiment of the invention to manage the sensitivity of practical optical fibers to Cherenkov radiation.

The processing electronic circuit may perform a subtraction between signals from photodetectors.

It is thus a feature of at least one embodiment of the invention to provide a simple method of knowing Cherenkov radiation that may employ common instrumentation including, for example, a differential electrometer.

The invention may provide a jacket surrounding both the detection optical fiber and the correction optical fiber to retain them together.

It is thus a feature of at least one embodiment of the invention to provide a simple sensor system that handles both correction and detection optical fiber as a unitary construction.

The jacket may be a water-equivalent material providing x-ray attenuation equivalent spectrally to that of water.

It is thus a feature of at least one embodiment of the invention to eliminate “coloring” effects from the jacket by matching them to common body tissue characteristics.

The light detecting module may include a housing providing a Faraday shield of a non-ferromagnetic material.

It is thus a feature of at least one embodiment of the invention to reduce eddy currents in the detection electronics which necessarily provide conductive elements. Such eddy currents are produced by rapidly changing magnetic fields provided by the MRI equipment.

The shielded cable may provide a non-ferromagnetic center conductor with a coaxially surrounding non-ferromagnetic braid.

It is thus a feature of at least one embodiment of the invention to reduce risks of magnetically induced forces on the cabling such as may be attracted by the strong magnetic field of the MRI machine.

The radiation detector may include an electronic display such as a differential electrometer.

It is thus a feature of at least one embodiment of the invention to provide a system that can work with instrumentation that is not necessarily “hardened” for use in an MRI environment, The displacement provided by the optical fiber and shielded cable allows such equipment to be placed outside of a region of influence of the MRI machine.

The detection optical fiber may be at least one-half millimeter in diameter.

It is thus a feature of at least one embodiment of the invention to provide a system that provides a robust measurement over a relatively large volume area through the use of the large diameter optical fiber.

The detection optical fiber may be fabricated of a polymer selected from the group consisting of polystyrene and acrylic.

It is thus a feature of a least one embodiment of the invention to provide a system that may work with a variety of optical fiber types.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a simplified block diagram of an MRI system providing radiation therapy capabilities and showing displacement of the detection electronics of the fiber optic sensor outside of the imaging field of the MRI machine, with expanded views of the various components of the detector, the detection electronics, and the readout module; and

FIG. 2 is an exploded perspective view of a modified triaxial connector and cable suitable for use with the present invention.

### DETAILED DESCRIPTION OF THE PREFERRED EMBODIMENT

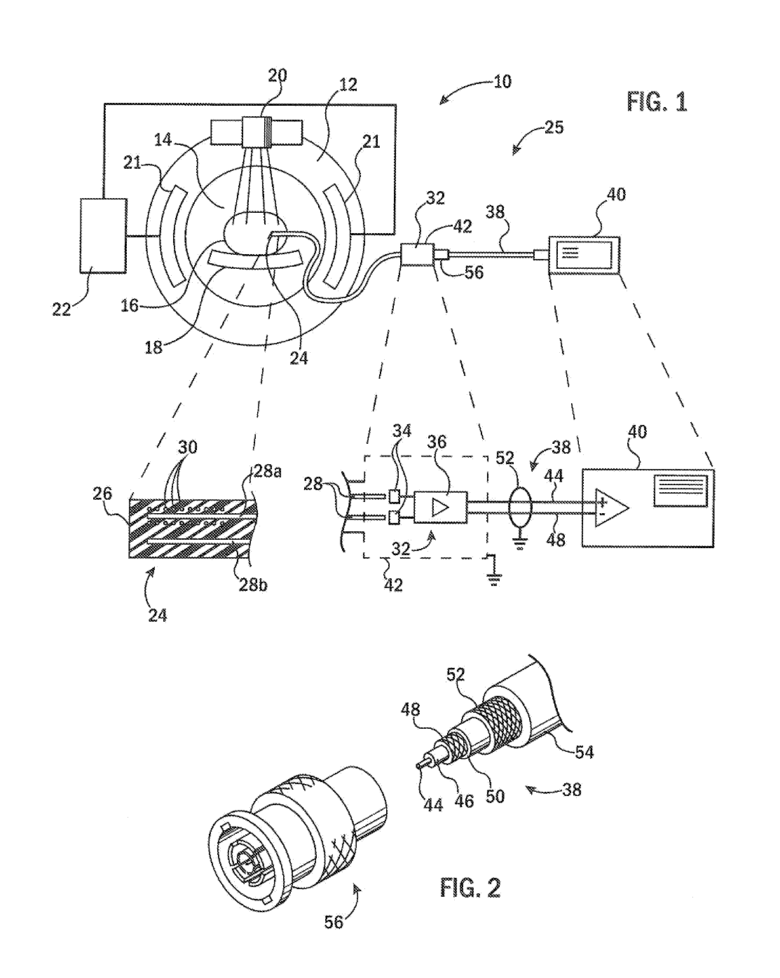

Referring now to FIG. 1, an MRI machine 10 may include a magnet 12 producing a polarizing magnetic field (for example, generally directed out of the page) typically in the range of one or more Tesla within an imaging region 14 of the MRI machine 10. The imaging region 14 may hold a patient 16 supported within the imaging region 14 on a patient table 18. Radiofrequency coils 21 of the MRI machine 10 are positioned adjacent to the imaging region 14 as shown or placed directly on the patient and are driven by radiofrequency amplifier/detector circuitry 22.

During operation of the MRI machine 10, the radiofrequency amplifier/detection circuitry is operated to stimulate the precession of protons within patient tissue. This precession, as modified by various magnetic gradient coils. may then be detected by the radiofrequency coils 21 (or other coil structures) to produce an MRI image of the patient 16 within the imaging region 14.

The MRI machine 10 may include or be used together with a radiation source 20 directing radiation along a number of angles through the patient 16 within the imaging region 14 during a radiation therapy session. The radiation source 20 may provide for mega-voltage x-rays, protons, electrons, or other high-energy charged particles as is generally understood in the art. A combination of the MRI machine 10 and the radiation source 20 allows tracking of patient structure during a radiation therapy operation to ensure correct placement of radiation dose.

In order to monitor the radiation dose, a probe 24 of a radiation detector 25 may be attached to or inserted into the tissue of the patient 16 for sensing the radiation dose provided by the radiation source 20 during treatment. The probe 24 may provide a water-equivalent, flexible plastic jacket 26 holding detection and correction optical fibers 28a and 28b therein and extending along their length. The detection and correction optical fibers 28a and 28b may, for example, have one-millimeter diameter cores surrounded by a 2.2 millimeter diameter jacket 26 and may be 3-10 meters long. As is understood in the art, water equivalence refers to the property of the material to exhibit an x-ray attenuation as a function of x-ray energy equivalent to that exhibited by water.

Detection optical fiber 28a may be treated at one end with a scintillating material 30 that produces scintillation light in response to being struck by radiation from the radiation source 20. Alternatively detection optical fiber 28a may incorporate a scintillating material, such as a scintillating organic molecule, into the polymer material. In one embodiment, the detection optical fiber 28a is polystyrene. An example optical fiber that may be used for the detection optical fiber 28a is the one-millimeter diameter BCF-60 available from Saint-Gobain Crystals, Paris, France.

The correction optical fiber 28b may be free from the scintillating material 30 and otherwise identical in dimensions to the detection optical fiber 28a. Correction optical fiber 28b in one embodiment may be constructed of acrylic (PMMA). An example correction optical fiber 28b is the one-millimeter diameter Eska Premier available from Mitsubishi Rayon Co., Ltd., Tokyo, Japan or the Raytela High-NA Plastic Optical Fiber from Toray International of Thailand.

By using polymer materials, the detection optical fiber 28a and correction optical fiber 28b can be entirely water-equivalent materials. This allows one or more of the probes 24 to be placed in the X-beam without substantially perturbing the delivered dose distribution.

Both detection and correction optical fibers 28a and 28b will also produce Cherenkov radiation caused when charged particles pass through a dielectric medium at a speed greater than the phase velocity of light in that medium. This Cherenkov radiation may exceed that produced by the scintillator. Multiple techniques for correcting for Cherenkov radiation will be described below.

The probe 24 may be generally flexible to be conducted outside of the imaging region 14 to remotely locate detection electronics 32, for example, as much as one meter away from the tip of the probe 24 placed on or in the patient 16 and typically as much as three meters away from the tip of the probe 24 so placed. The detection electronics 32 may include a first and second electronic photodetector 34 such as photodiodes or phototransistors and processing electronics 36 (for example, buffer amplifiers, filters and the like) which together measure the light from each of the detection and correction optical fibers 28a and 28b to create an electronic signal for each that may be transmitted through triaxial cable 38 to a differential electrometer 40. The differential electrometer 40, in one embodiment, may generally subtract the signals from the photodetectors 34 for each of the detection and correction optical fibers 28a and 28b to produce a difference value that provides a measure of the light from the scintillating material 30, and hence the scintillator-detected radiation, without the contribution from the generated Cherenkov radiation.

Alternatively, the Cherenkov radiation may he separated from the treatment radiation-induced scintillation using only a single fiber (coupled to a scintillating fiber) and chromatic separation, for example, as described in: M. Guillot, L. Gingras, L. Archambault, S. Beddar, and L. Beaulieu, “Spectral method for the correction of the Cerenkov light effect in plastic scintillation detectors: a comparison study of calibration procedures and validation in Cerenkov light-dominated situations,” Medical Physics, vol. 38, no. 4, pp. 2140-2150, 2011. In this technique, separate calibration factors a and b are applied to the light from the detection optical fibers 28a at two different frequency ranges to deduce received dose. Using this method, an additional condition is imposed that the ratio of the two calibration factors must be equal to the ratio of the Cherenkov light measured within the two different spectral regions used for analysis.

The probe 24 may be substantially free of magnetic or electrically conductive material so as to be uninfluenced by the magnet 12 and to be substantially immune from induced eddy currents from the radiofrequency coils 21 and to minimize field disturbances in the vicinity of the probe 24 such as may affect the imaging of the MRI machine 10.

The detection electronics 32 are constructed to be substantially free of ferromagnetic material (including ferrous materials and nickel) but will include electrically conductive components which are shielded in a Faraday shield 42 of a non-ferromagnetic material such as brass to protect these components against interference from the radio frequencies of the MRI machine 10. This shielding and removal of the detection electronics 32 from the imaging region 14 greatly reduces any interference between the MRI machine 10 and the detection electronics 32.

Referring to FIG. 2, triaxial cable 38 may be constructed according to generally understood principles to provide a central conductor 44 surrounded by an insulating dielectric 46 in turn surrounded by a conductive braid 48. The conductive braid 48 is then in turn surrounded by an insulating dielectric 50 which is then surrounded by a conductive braid 52 and finally by an insulating jacket 54. The triaxial cable 38 may be modified from standard designs by eliminating any ferromagnetic materials. A triaxial BNC-type connector 56 typically constructed of nickel-plated brass may be modified to remove the nickel plating in exchange for a clear polymer coating. Generally nickel and ferrous materials are fully eliminated from the detection electronics 32 and the triaxial cable 38. Optionally, the stainless steel braid normally used for triaxial conductive braids 48 and 52 is replaced with copper braid.

Specifically, the central conductor 44 replaces a typical, silverplated, copper-covered steel center wire with a silverplated solid copper wire, for example, having a wire diameter of 0.013. The conductive braids 48 and 52 may be silverplated copper. An additional layer of conductive PVC (not shown) may be placed around the dielectric 46 within the braid 48, while maintaining a standard electrical impedance of 50 ohms and 25 picofarads per foot.

Electrometer 40 may be placed sufficiently far from the MRI machine 10 to require no modification other than eliminating large ferromagnetic components. An electrometer suitable for use with the present invention is the SuperMax Electrometer commercially available from Standard Imaging, Inc of Middleton, Wis.

In an alternative design, the radiation detector may use the principles described in U.S. Pat. No. 8,183,534, hereby incorporated by reference, to cancel out of Cherenkov radiation through the use of two different phosphor types.

In an alternative embodiment of the invention, the length of the optical fibers 28 may be increased, for example, beyond 3 meters to as much as 10 meters. In this case, the shielded triaxial cable 38 may be omitted and the electronics 36 functionality of the electrometer 40 incorporated into a single Faraday shield, this integration is possible with the greater displacement of the electronics from the magnet 12.

It will be appreciated that the labels of “correction optical fiber” and “detection optical fiber” are provided for clarity and that the function of both optical fibers may contribute to both detection and correction in some embodiments.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

We claim:

1. A radiation detector comprising:
a detection optical fiber communicating with a scintillating material responsive to radiation at a distal end;
a light detecting module communicating with a proximal end of the detection optical fiber to receive light through the detection optical fiber from the scintillating materials, the light detecting module providing at least one photodetector; and
a shielded cable communicating with the photodetector and adapted to conduct an electrical signal from the photodetector to an electronic display remote from the photodetector;
wherein the light detecting module and shielded cable are substantially free from ferromagnetic materials.

2. The radiation detector of claim 1 wherein the detection optical fiber has a length no less than one meter long.

3. The radiation detector of claim 1 further including a correction optical fiber having a different relative response to radiation at its distal end than the detection optical fiber has at its distal end;
wherein the light detector module includes a separate photodetector for the correction optical fiber and the detection optical fiber; and
further including a processing electronic circuit for combining signals from the photodetectors to provide the electrical signal with reduced sensitivity to Cherenkov radiation generating light within each of the detection and correction optical fibers.

4. The radiation detector of claim 3 wherein the processing electronic circuit performs a subtraction between signals from the photodetectors.

5. The radiation detector of claim 3 further including a jacket surrounding both the detection optical fiber and the correction optical fiber to retain them together.

6. The radiation detector of claim 5 further wherein the jacket is a water-equivalent material providing x-ray attenuation equivalent spectrally to that of water.

7. The radiation detector of claim 1 wherein the light detecting module includes a housing providing a Faraday shield of a non-ferromagnetic material.

8. The radiation detector of claim 1 wherein the shielded cable provides a non-ferromagnetic center conductor with a coaxially surrounding non-ferromagnetic braid.

9. The radiation detector of claim 1 wherein the light detecting module is substantially free from ferromagnetic materials.

10. The radiation detector of claim 1 further including the electronic display.

11. The radiation detector of claim 10 wherein the electronic display is a differential electrometer.

12. The radiation detector of claim 1 wherein the detection optical fiber is at least one-half millimeter in diameter.

13. The radiation detector of claim 1 wherein the detection optical fiber is fabricated of a polymer selected from the group consisting of polystyrene and acrylic.

14. A radiation detector comprising:
a detection optical fiber communicating with a scintillating material responsive to radiation at a distal end;
a correction optical fiber having a different relative response to radiation at its distal end than the detection optical fiber has at its distal end;
a light detecting module communicating with a proximal end of the detection optical fiber to receive light through the detection optical fiber from the scintillating materials at a first photodetector, and to receive light through the correction optical fiber at a second photodetector; and
a processing electronic circuit for combining signals from the first and second photodetectors to provide the electrical signal with reduced sensitivity to Cherenkov radiation generating light within each of the detection and correction optical fibers;
wherein the light detecting module and processing electronic circuit are contained in a Faraday shield substantially free from ferromagnetic materials.

15. The radiation detector of claim 14 wherein the processing electronic circuit performs a subtraction between signals from the photodetectors.

16. The radiation detector of claim 14 further including a jacket surrounding both the detection optical fiber and the correction fiber to retain them together.

17. The radiation detector of claim 16 further wherein the jacket is a water-equivalent material providing x-ray attenuation equivalent spectrally to that of water.
